(19) United States
(12) Patent Application Publication
(10) Pub. No.: US 2026/0353517 A1
(43) Pub. Date: Nov. 5, 2026

(54) FLEXIBLE PRINTED HEATING PADS

(71) Applicant: FLOTHERM, INC., Los Angeles, CA (US)

(72) Inventors: Douglas Patton, Newport Beach, CA (US); Sean Patton, Irvine, CA (US)

(21) Appl. No.: 19/666,142

(22) Filed: May 1, 2026

Related U.S. Application Data
(60) Provisional application No. 63/798,347, filed on May 1, 2025.

(51) Int. Cl. H05B 3/34

(52) U.S. Cl. CPC H05B 3/342

(57) ABSTRACT

A device may include a flexible sleeve adapted to fit over a portion of a patient’s body, wherein the flexible sleeve is stretchable to conform to the patient’s body. A device may include a first flexible heating element adhered to the flexible sleeve, wherein the first flexible heating element is stretchable to bend and stretch with the flexible sleeve.

### CROSS-REFERENCE TO RELATED APPLICATIONS

This application claims priority to U.S. Provisional Application No. 63/798,347, filed May 1, 2025, the disclosure of which is hereby incorporated by reference in its entirety.

### BACKGROUND

### Field

The present disclosure relates to the field of heater devices.

### Description of Related Art

Heater devices can be used for various applications, including heating a patient during the course of a surgical procedure or other periods. Features of such heater devices, such as profile, heating surface area, and flexibility, can have an effect on heater performance, comfort, and/or other parameters.

### SUMMARY

Described herein are systems, devices, and methods for transferring heat. Such heat transfer can be facilitated using certain heat pads and heat pad assemblies. Generally, the conformity of such heating pads to the surface (e.g., anatomy) being heated can affect the amount of heat transfer. Embodiments of the present disclosure include heating pads with shapes, profiles, conductive tracing patterns, and/or other parameters that facilitate efficient heat transfer.

In some implementations, the present disclosure relates to a heating assembly comprising a flexible sleeve adapted to fit over a portion of a patient’s body, wherein the flexible sleeve is stretchable to conform to the patient’s body and a first flexible heating element adhered to the flexible sleeve, wherein the first flexible heating element is stretchable to bend and stretch with the flexible sleeve.

In some examples, the heating assembly further comprises a flexible substrate disposed between the flexible sleeve and the first flexible heating element. The first flexible heating element comprises one or more electrically conductive heating traces configured to radiate heat therefrom in response to electrical current flowing through the one or more electrically conductive heating traces.

The first flexible heating element is adhered to an upper portion of the flexible sleeve to position the first flexible heating element adjacent to the patient’s knee. In some examples, the heating assembly further comprises a second heating element adhered to the flexible sleeve, wherein the second heating element is stretchable to bend and stretch with the flexible sleeve.

In some examples, the second heating element is adhered to a lower portion of the flexible sleeve to position the second heating element adjacent to the patient’s foot. The heating assembly may further comprise a compression bladder attached to the flexible sleeve between the first heating element and the second heating element.

The heating assembly may further comprise a thermistor disposed adjacent to the first heating element to sense skin temperature. In some examples, the heating assembly further comprises a controller electrically coupled to the thermistor to communicate with the thermistor and adjust heating temperature at the first heating element in response to the sensed skin temperature.

In some examples, the heating assembly further comprises a compression bladder attached to the flexible sleeve, wherein the controller is electrically coupled to the compression bladder to control compression of the compression bladder in response to the sensed skin temperature. The flexible sleeve may be adapted for placement on a patient’s arm, shoulder, thoracic area, or head.

The first heating element may be printed to the flexible sleeve. In some examples, the heating assembly further comprises one or more electrical leads coupled to the first heating element, wherein the one or more electrical leads are flexible to conform to bend and stretch with the flexible sleeve. In some examples, the one or more electrical leads are printed to the flexible sleeve.

The heating assembly may further comprise a flexible substrate coupled to the flexible sleeve and adapted to stretch and bend with the flexible sleeve, wherein the one or more electrical leads are coupled to the flexible substrate.

Some implementations of the present disclosure relate to a heating assembly comprising a flexible sleeve adapted to fit over a portion of a patient’s body, wherein the flexible sleeve is stretchable to conform to the patient’s body, a first flexible heating element adhered to the flexible sleeve, wherein the first flexible heating element is stretchable to bend and stretch with the flexible sleeve, a second flexible heating element adhered to the flexible sleeve, wherein the second flexible heating element is stretchable to bend and stretch with the flexible sleeve, and a compression bladder attached to the flexible sleeve between the first flexible heating element and the second flexible heating element.

In some examples, the heating assembly further comprises a flexible substrate disposed between the flexible sleeve and the first flexible heating element. The first flexible heating element may comprise one or more electrically conductive heating traces configured to radiate heat therefrom in response to electrical current flowing through the one or more electrically conductive heating traces.

Some implementations of the present disclosure relate to a heating assembly comprising a flexible sleeve adapted to fit over a portion of a patient’s body, wherein the flexible sleeve is stretchable to conform to the patient’s body, a flexible substrate adhered to the flexible sleeve, a first flexible heating element adhered to the flexible substrate, wherein the first flexible heating element is stretchable to bend and stretch with the flexible sleeve, and a second flexible heating element adhered to the flexible substrate.

The heating assembly may further comprise a compression bladder attached to the flexible sleeve between the first flexible heating element and the second flexible heating element.

### BRIEF DESCRIPTION OF THE DRAWINGS

Various embodiments are depicted in the accompanying drawings for illustrative purposes and should in no way be interpreted as limiting the scope of the inventions. In addition, various features of different disclosed embodiments can be combined to form additional embodiments, which are part of this disclosure. Throughout the drawings, reference numbers may be reused to indicate correspondence between reference elements.

FIGS. 1A–1E illustrate a heating and/or compression system for providing blood flow assistance, in accordance with one or more examples.

FIGS. 2A and 2B illustrate an example heating and/or compression system disposed on a patient’s leg, in accordance with one or more examples

FIGS. 3A and 3B illustrate example heating elements of a system in accordance with one or more examples

FIG. 4 illustrates example placement of the heating and/or compress systems described herein.

FIGS. 5A and 5B illustrate an example lower sleeve in accordance with one or more examples.

FIG. 6 illustrates two states of an example heating element in accordance with one or more examples.

FIG. 7 back and perspective views of an example heating and/or compression system in accordance with one or more examples.

FIG. 8 illustrates heating elements of a system in accordance with one or more examples.

FIG. 9 provides side and perspective views of an example system for providing compression and/or heating to a patient in accordance with one or more examples.

### DETAILED DESCRIPTION

The headings provided herein are for convenience only and do not necessarily affect the scope or meaning of the claimed invention. Although certain preferred embodiments and examples are disclosed below, inventive subject matter extends beyond the specifically disclosed embodiments to other alternative embodiments and/or uses and to modifications and equivalents thereof. Thus, the scope of the claims that may arise herefrom is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Although certain spatially relative terms, such as “outer,” “inner,” “upper,” “lower,” “below,” “above,” “vertical,” “horizontal,” “top,” “bottom,” and similar terms, are used herein to describe a spatial relationship of one device/element or anatomical structure to another device/element or anatomical structure, it is understood that these terms are used herein for ease of description to describe the positional relationship between element(s)/structures(s), as illustrated in the drawings. It should be understood that spatially relative terms are intended to encompass different orientations of the element(s)/structures(s), in use or operation, in addition to the orientations depicted in the drawings. For example, an element/structure described as “above” another element/structure may represent a position that is below or beside such other element/structure with respect to alternate orientations of the subject patient or element/structure, and vice-versa. It should be understood that spatially relative terms, including those listed above, may be understood relative to a respective illustrated orientation of a referenced figure.

Certain reference numbers may be re-used across different figures of the figure set of the present disclosure as a matter of convenience for devices, components, systems, features, and/or modules having features that are similar in one or more respects. However, with respect to any of the embodiments disclosed herein, re-use of common reference numbers in the drawings does not necessarily indicate that such features, devices, components, or modules are identical or similar. Rather, one having ordinary skill in the art may be informed by context with respect to the degree to which usage of common reference numbers can imply similarity between referenced subject matter. Use of a particular reference number in the context of the description of a particular figure can be understood to relate to the identified device, component, aspect, feature, module, or system in that particular figure, and not necessarily to any devices, components, aspects, features, modules, or systems identified by the same reference number in another figure. Furthermore, aspects of separate figures identified with common reference numbers can be interpreted to share characteristics or to be entirely independent of one another.

### Overview

The present disclosure relates to systems, devices, and methods for heating and/or maintaining normothermia for a patient, such as during a medical procedure/surgery. In hospitals, patients are typically cold due to sheer robes and very cold temperatures. Typically in pre-op, patients are very cold and require blankets. However, they may be transferred on a gurney to the operating room (OR) through the hospital with no warming. Patients can then remain for 30-60 minutes before surgery on a cold, stainless steel table. Their core body temperature will drop significantly during this time, which is a major cause of hypotension. The efficacy of successful surgeries are undermined by this hypotension. A major contributor to hypotension is low core body temperature. Additionally, in post-op this problem continues, where the patient is cold and monitoring their core body temperature is difficult in a busy hospital.

Examples herein provide an innovative system and/or method to provide sequential compression to the calf muscle during surgery with adjacent heaters above (e.g., popliteal knee area) and below (e.g., the bottom of the foot) to maintain blood flow before, during, and/or after surgery. This effectively creates a heated supply of blood that circulates through the body, effectively raising the core body temperature.

Each year, over 60 million surgical procedures are performed in the United States. While great care may be taken to prevent surgical complications, one commonly overlooked and under-addressed problem is the risk of developing hypothermia before, during, or after surgery (referred to as “inadvertent perioperative hypothermia” or “IPH”). For example, patient temperatures can drop precipitously during surgery due to the effects of general anesthesia, lack of insulating clothing, and/or exposure to cold operating room temperatures. Even with modern standards of care, approximately 30–50% of surgical patients may develop hypothermia.

Hypothermia often causes much more than patient discomfort. Patients who suffer even mild IPH can face a significantly elevated risk of developing surgical site infections, cardiac morbidities, intraoperative bleeding, and other avoidable complications. Together, these complications can significantly increase recovery time and overall length of hospital stay, leading to increased costs for all parties. By some estimates, the unmanaged risk for IPH is a $15 billion problem in the United States alone, and yet it is largely overlooked.

Perioperative heat loss can occur predominantly via convective heat transfer, particularly through the palms of the hands, soles of the feet, and exposed surgical site surface area. During preoperative care, patients are often dressed solely in a gown and are often exposed to relatively cold waiting areas with little to no insulation. Although patients are generally only anesthetized at the start of surgery, patients often arrive at the surgical theater moderately hypothermic. This can put a patient at greater risk for developing severe hypothermia once anesthesia has been administered. Postoperative drops in core temperature can increase the likelihood of developing additional comorbidities, such as morbid cardiac outcomes, surgical site infections, and blood loss, any of which can prolong recovery and hospitalization.

Patients undergoing surgery can develop hypothermia during the surgical procedure itself, especially when the procedure involves the patient’s core area, such as procedures involving the posterior or anterior sides of the thoracic, abdominal, and pelvic regions. Surgeries of the core involve the exposure of vital internal organs to the colder environment and thus carry a greater risk of hypothermia. Furthermore, core surgeries often necessitate uncovering of the trunk and chest, which render blankets and many other currently-available interventions inadequate. Once in the operating room, patients may be naked and exposed to a room temperature well below 36 degrees Celsius and to cold liquids used to wash the surgical site during sterilization preparation. At the onset of surgery, delivered anesthetics can immediately impair the normal autonomic thermoregulatory controls. Colder blood may be transferred from the peripheries of the body to the core through a phenomenon known as redistributive hypothermia. Vasodilatation and reduction in muscle tone can cause a significant drop in core temperature within the first half-hour of surgery.

Overall, compared to non-hypothermic patients, those who suffer from IPH experience greater rates of surgical site infections, bleeding, and cardiac complications. Such issues may require additional monitoring and/or increase the length of stay and/or subjective discomfort. The development of IPH is strongly correlated with a multitude of physiological organ system changes impacting the cardiovascular, respiratory, neurologic, immunologic, hematologic, drug-metabolic, and wound-healing mechanisms. The incidence of several post-surgical complications can be increased due to even mild hypothermia.

Intraoperatively, hypothermia can cause a decrease in cardiac output and heart rate, which can lead to ventricular dysrhythmias. Platelet functions can become impaired and there can be a decrease in coagulation factors, which can, in turn, lead to greater intraoperative bleeding and blood loss. Impaired immune functions can increase the rate of surgical site infections. Hypothermia is associated with a four-fold increase in surgical wound infection and twice as many morbid cardiac events. In select procedures such as colorectal, gynecologic, or spinal surgery, where infection rates are normally higher than other surgeries, hypothermia can be exceedingly dangerous to the intraoperative and postoperative recovery. These complications and others are supported in multiple studies and can result in both clinical and economic burdens.

Current methods of preventing hypothermia often are not completely effective. Even with the current interventions, up to 46% of patients are reported to be hypothermic at the start of surgery, and 33% are hypothermic upon arrival to the post-anesthesia care unit (PACU). Assuming the cost savings for maintaining normothermia in one patient is approximately $5,000 per patient, and approximately 30% of the 17 million high-risk surgical patients are hypothermic, a system-wide cost savings of $15 billion could be realized by keeping these patients normothermic. With rising healthcare costs and recent initiatives mandating the maintenance of perioperative normothermia, hospital administrators are in need of new, efficacious, and cost-effective devices to address perioperative hypothermia, a product space that has seen little innovation since the introduction of the forced-air warming blanket nearly three decades ago.

Some solutions for perioperative warming may implement forced-air temperature management devices (e.g., warming blankets). For example, some temperature management solutions utilize high-heat transfer conduction heating blankets and intraoperative hand-warming devices. In embodiments in which heated fluid exits a blanket device towards the patient and/or into the surgical environment, such air may introduce certain contaminants into the surgical environment, which can result in infection or other medical issues. That is, it may be desirable for the surgical environment to be substantially sterile to prevent exposure of the patient anatomy, which may be of a particular concern with respect to internal patient anatomy that may be exposed to the surgical environment during the relevant procedure/operation. Forced-air, blanket-type heating systems may further present a relatively cumbersome physical structure that can get in the way, such as when the blanket is disposed in an area near the surgical site. Furthermore, in some situations, operating room staff may turn down the temperature on a forced-air device in consideration of their own comfort, as forced-air systems can heat the surrounding air/environment. Moreover, certain devices may not be used in preoperative warming for one or more of the following reasons, among others: (1) some devices may immobilize the upper limbs, impeding patient mobilization; (2) devices may be cumbersome (e.g., a device may float on the patient and get blown off or fall off during use and/or transport, and they require large, predominantly floor-based blowers that may not be mobile; (3) they may not attach to the patient and/or can become dislodged during transport and obstruct the bed and other monitors and devices; and (4) they can require a conscious administrative decision to implement.

Embodiments of the present disclosure advantageously provide certain improved devices, methods, and systems for maintaining a patient’s core body temperature before, during, and/or after surgery. In some embodiments, lower limbs of patients may be leveraged to provide therapy and/or enable mobility. For example, some devices described herein may provide flexibility and/or one or more spaces around a knee, ankle, and/or other portions of a patient’s body to allow the patient to flex and/or extend the limbs. Such patient mobility may provide a variety of benefits, including allowing patients to stand up to use the restroom without removing and reapplying the device.

Some embodiments of temperature management devices disclosed herein may be configured to provide warming to one or more arteries and/or veins passing along the patient’s lower limbs. Moreover, some embodiments may utilize electrical heating pads comprising one or more electrical conductors configured to radiate heat in response to the flow of electrical current therethrough.

### Flexible Heaters

Thermoplastic Polyurethane (TPU) is a versatile thermoplastic elastomer combining the elasticity of rubber with the toughness and processability of plastics. Examples herein relate to TPU flexible printed heaters adapted to consume less power than traditional heating methods. Such heaters reach target temperatures quickly (e.g., often within a minute), reducing energy consumption and lowering electrical voltage and/or may be advantageous for warming patients quickly.

Conductive fillers for TPU are useful for applications requiring electrical conductivity. There are a variety of types, including Carbon Nanotubes (CNTs), Graphene Nanoplates (GNPs), Activated Carbon (AC), and Metallic Fillers. CNTs are dispersed throughout polyarylene sulfide matrices and provide percolation networks enabling electrical conductivity while maintaining mechanical integrity at extreme temperatures. GNPs are incorporated onto the surface of BNNSs and construct efficient thermally conductive pathways, resulting in a higher conductivity of the composite. At concentrations ranging from 0 to 10%, AC enhances interfacial polarization and charge mobility, improving dielectric performance and influencing conductivity mechanisms. Surface-modified thermal metallic fillers like titanium-based and zirconium-based modifiers enable simultaneous thermal conductivity and electrical insulation in poly acrylonitrile-butadiene-styrene (ABS)/polyolefin blends.

These fillers are engineered through dynamic vulcanization processes, whereby rubber phases are selectively crosslinked within a continuous thermoplastic matrix, followed by strategic incorporation of conductive additives. The resulting composites exhibit unique multifunctional properties, including flexibility, recyclability, and tailored conductivity

TPU-based flexible printed heater systems and/or inks resist cracking and delamination and wear even in harsh conditions. This durability ensures a longer lifespan and reduced maintenance for long-term use. TPU-based flexible printed heaters are ultra-thin, lightweight, and conformable. The printed heaters can be customized to fit any human body form and heating requirement and/or can conform to the most irregular surfaces of the body, providing efficient heating.

Example heating systems herein provide heat distribution across complex surfaces, improving energy efficiency and reducing hot spots. Systems may include a control loop wherein a heater is continuously monitored to adjust temperature, preventing overheating and ensuring safe optimal performance. TPU-based heaters are perfect for conforming to the area behind the knee, the foot, and other body parts where flexing and bending are required.

In one example, a hot melt adhesive (HMA) system allows heaters and/or a thermistor to be installed firstly on an application substrate and then bonded on a profile as thin as 5 millimeters, allowing for integration into tight spaces to the stretch fabric. In another embodiment, the printed heater and/or thermistor can be printed and/or applied directly onto stretchable fabric.

The heater stretch can be up to 30% of the original form. The operational voltage can range from 5 VDC to 12 VDC. The power can be as low as 13 watts with the resistance of 3.5 ohms only requiring 1.9 to 3.1 amps. The operating temperature can range from below 98.6°F to 140°F. The connector system can be AD-bit flat flying W4 GA wire. Additionally, since the voltage to heat the system is low, heating systems described herein can be operated with a battery for long-term use.

In another embodiment, the thermoplastic matrix or thermoplastic elastomer (TPE) may be selected from Polylactic Acid (PLA), cellulose acetate, polyethylene, Polyvinyl chloride, polypropylene, styrene-butadiene-acrylonitrile terpolymer, polystyrene, makrolon, nylon 6 and/or thermoplastic property polyurethane.

Systems can include a conductive filler, which can comprise CNT, chemistry-thermal reduction graphene, carbon that is chopped of nano metal particles modification are fine dimension or nano silver wire.

To regulate the heating of the body, example heaters may have a dual application of safety and efficacy. Firstly, the heater may remain in contact with the skin to aid in heating the core body temperature. This is accomplished with a flexible heater and/or fabric, similar to a sock and/or stocking. Secondly, a thermistor (e.g., temperature sensor) may maintain contact with the skin to monitor and control skin temperature. The flexible heater and/or fabric may assure that contact of the thermistor and the skin is maintained.

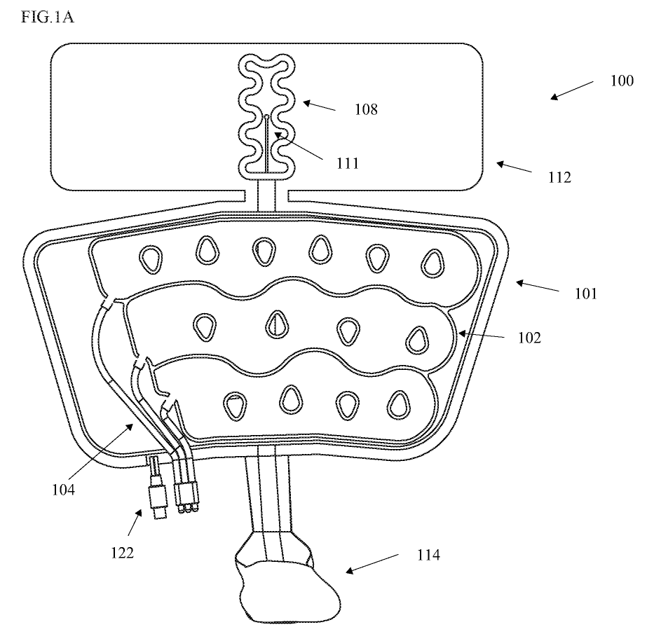

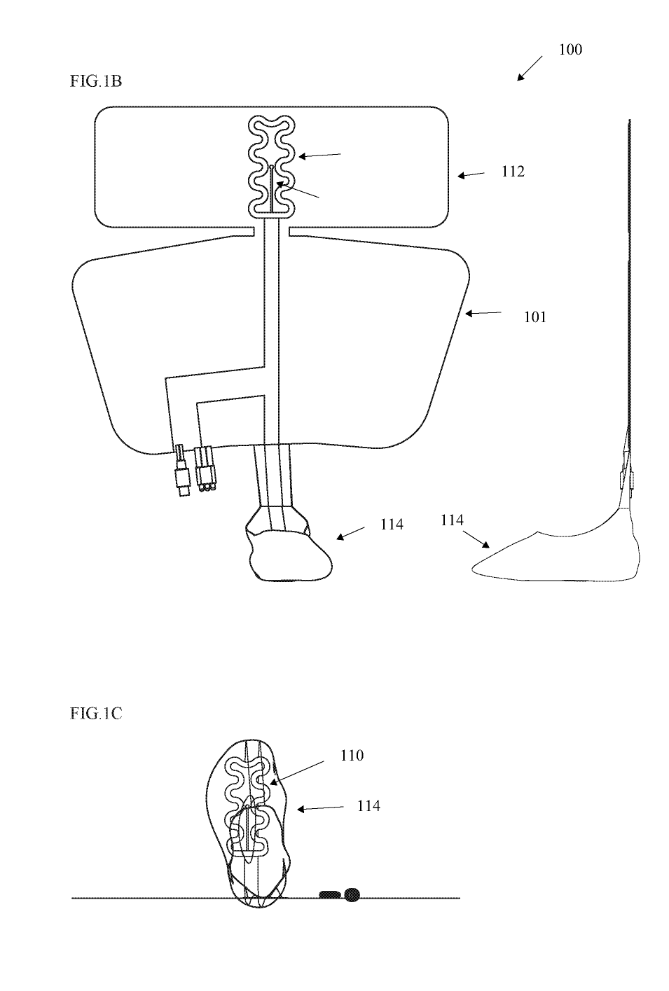

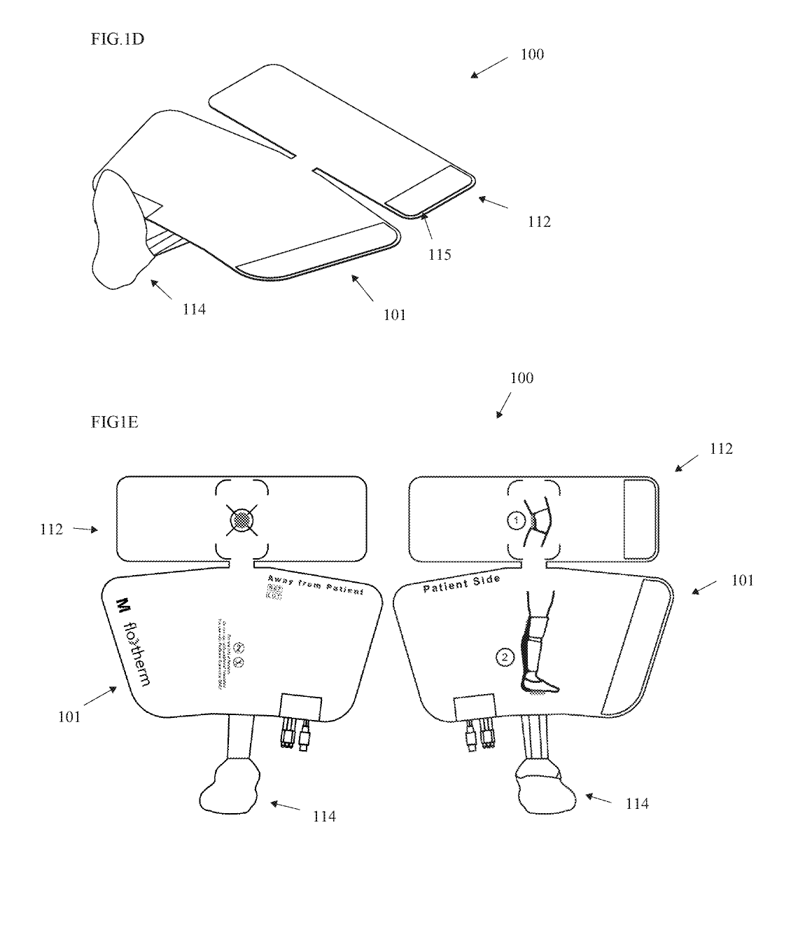

FIGS. 1A–1E illustrate a heating and/or compression system 100 for providing blood flow assistance, in accordance with one or more examples. FIG. 1A provides a transparent front view of the system 100. The system 100 includes a compression device 101 including inflatable bladders 102 (e.g., three inflatable bladders) and inflation tubes 104 (e.g., three tubes) providing gas and/or fluid to the bladders 102. However, other amounts of bladders and/or tube connectors may be used. The system 100 may also include a first heating device 108 and/or additional heating devices coupled to an upper sleeve 112 (e.g., knee sleeve) and/or lower sleeve 114 (e.g., foot sleeve and/or pad). The bladders may be sequentially inflated and/or deflated via the tubes. The first heating device 108 may have any suitable size and/or shape. In some examples, the first heating device 108 may form at least partial loop and/or may have a zig-zag form. The system 100 may comprise a thermistor 111 disposed within the first heating device 108 and/or surrounded by the first heating device 108 to detect temperature at and/or around the first heating device 108. Additional heating elements of the system 100 may similarly have associated thermistors. The first heating device 108 and/or other heating devices may have any suitable arrangements, forms, sizes, and/or layouts to conform to specific body parts.

The system 100 may comprise a body-wearable structure/article/garment configured to be disposed about at least a portion of a limb of the patient, such as a lower limb/leg. The term “sleeve” is used herein according to its broad and ordinary meaning, and may refer to any type of sleeve, garment, article, brace, cuff, sock, boot, wrap, or the like configured to be placed and/or secured on or about a limb or other body part of a person. The thermal-management sleeve can include one or more physical connectors, which may include one or more straps, clips, clasps, folds, elastically-deformable materials or components, wraps, or other physical components of the sleeve that may be used to secure the sleeve to the limb of the patient.

The sleeve can include one or more compression bladders 102, which may be configured to receive fluid through one or more fluid interfaces/connectors from a fluid source of a control unit or system. In some embodiments, the sleeve includes 2, 3, or more compression bladders, which may be individually inflatable and/or depletable to provide sequential compression of the limb of the patient. Although described as compression bladders for convenience, it should be understood that the feature(s) may comprise any type of compression elements. In some embodiments, certain electrical wiring or other electrical connectivity component(s) may be coupled to each compression element for providing electrical power to the respective compression element. For example, electrical current may be provided to the compression element(s) to initiate mechanical tightening or relaxing of the element(s) in order to provide sequential compression of the limb of the patient.

The sleeve may further have associated therewith a heater assembly including a first heating element 108, which may be removably and/or permanently attached or secured to the sleeve. The heater assembly can include a plurality of heating pads/devices.

The heating pads of the heater assembly may include a foot heating pad and a popliteal fossa heating pad. The term “heating pad” is used herein according to its broad and ordinary meaning, and may refer to a heating element that has a relatively broad surface configured to apply heat over a broad (e.g., relatively flat and/or contoured) area, such as an area of the sole of the foot and/or area of the popliteal fossa, or any other area corresponding to the form factor of the heating element/pad. Furthermore, the term “heating pad,” as used herein, may refer to the heating element itself, such as a resistive heating element implemented on an at least partially flat substrate or in an at least partially flat plane or form, and/or may be used to refer to a portion of a heater assembly including a heating element and one or more layers or components associated therewith and/or disposed adjacent thereto.

Although embodiments are described herein in the context of heating, it should be understood the various embodiments of temperature management systems and devices disclosed herein can be implemented to provide cooling to the limb of a patient. That is, any reference herein to heating, heating pads, heater assemblies, and/or other heating systems, processes, devices, or the like can be understood to refer to cooling, cooling pads, cooling assemblies, and/or other cooling systems, processes, devices, or the like. Furthermore, it should be understood that the various devices, systems, and processes disclosed herein can be used/implemented to perform or incorporate both heating and cooling functionality. In some embodiments, cooling using a cooling pad is implemented utilizing thermoelectric cooling element(s).

The structure of sleeves disclosed herein may include certain holes or other attachment features for attaching various components of a temperature-management system, including heater/cooler assemblies, physical connectors, tubes, pads, or other features. For example, certain straps (e.g., velcro) may be implemented to attach various components.

The thermistor 111 may be disposed and/or adhered at a widthwise center of the first heating device 108 and/or may be at least partially and/or fully enclosed by the first heating device 108. The thermistor 111 may be electrically coupled to one or more traces that may be routed on the upper sleeve 112 and/or along a flexible substrate along a path that does not overlap with the one or more electrically conductive heating traces of the first heating device 108.

The first heating device 108 may be disposed for placement above the compression device 101 to place the first heating device 108 behind and/or adjacent to a knee of a patient. A second heating device 110 (see, e.g., FIG. 1C) may be disposed for placement below the compression device 101 to place the second heating device 110 at a foot and/or along a bottom of a foot of the patient. The system 100 may comprise an 8-pin connector 122 for communication and/or direct interaction with a controller. The connector may be adapted to supply electrical energy to the first heating device 108 and/or to multiple heating devices.

In some examples, the first heating device 108 and/or second heating device 110 may be printable onto a fabric and/or material of the upper sleeve 112 and/or lower sleeve 114. For example, the first heating device 108 and/or second heating device 110 may be directly printed to fabric or applied through heat and pressure to the fabric of the upper sleeve 112 and/or lower sleeve 114. The compression device 101, upper sleeve 112, and/or lower sleeve 114 may comprise Velcro pads and/or other attachment features to allow for adjustable wrapping of the compression device 101, upper sleeve 112, and/or lower sleeve 114 to the patient to conform to a range of thigh, foot, and/or calf sizes.

The first heating element 108 and/or additional heating element(s) may comprise a heating pad assembly, which may have any suitable or desirable shape, form, and/or heating trace/conductor routing. Such a heating pad assembly may include one or more layers of certain heat-transfer media, which may not be present with respect to certain embodiments of heating pad assemblies in accordance with the present disclosure. For example, the heat-transfer media may comprise heat-transfer gel and/or other media configured to facilitate the transfer/conduction of thermal energy from the heating pad through the patient-facing side of the heating pad assembly. In some embodiments, the heat transfer medium is disposed on, over, and/or under one or more thermistors, which may be used to determine temperature conditions at or near the first heating device 108. In some embodiments, the heat-transfer medium comprises a silicone rubber with relatively high thermal conductivity, wherein such material may be suitable for, and/ or facilitate, pressure against the patient’s skin

The first heating device 108 may be any type of heating pad, such as a resistive radiating heating pad. For example, the first heating device 108 may comprise polyimide or other substrate material, which may be flexible or rigid in whole or in part. The first heating device 108, and/or thermistor(s) 111, may be coupled to electrical wiring, which may be electrically coupled to an electrical connector and/or controller.

The first heating device 108 and/or other heating device(s) can be secured to, or otherwise placed/disposed on, or secured or attached to the upper sleeve 112, lower sleeve 114 and/or other sleeve portion, which can include a wearable sleeve structure/article, such as a compression-enabled sleeve device as described herein. The heating device(s) can be configured for placement at or near the sole of a foot, the popliteal fossa of a leg, or any other anatomy or surface (e.g., bend of arm). In some embodiments, the heating device(s) are not contained within a pouch; in such embodiments, the relevant heater assembly components can be printed, stitched, welded, or otherwise secured to a sleeve member/article without a pouch. For example, the heating device(s) may be stitched, welded, or otherwise secured between layers of fabric or other material of the sleeve member/article, at least with respect to one or more portions of the heating pads.

The heating device(s) may include certain resistive electrical conductors configured to have electrical current passed therethrough, wherein such current produces radiant heat (e.g., in the form of infrared radiation), which may be used to provide heating to the patient. The electrical conductors may be printed on and/or disposed within one or more layers of non-electrically conductive substrate, which may be made of any suitable or desirable material, such as plastic/polymer (e.g., polyimide or other resin). Such substrate may advantageously be flexible to allow for conformity and/or contortion thereof for placement against various nonuniform topologies/surfaces. The traces/conductors can vary in thickness in different embodiments or in different portions/areas of a single embodiment to adjust the watt density and/or other parameter(s) of the respective heating pad(s), such as for the purpose of concentrating heat in certain areas of a heating pad or anatomy for desired (e.g., even) heating effect.

The heating device(s) may have associated therewith one or more thermistors 111, which may be disposed on and/or buried in a substrate, or may be mounted thereto as a discrete component/device. In some embodiments, the substrate includes certain electrical traces/conductors that are electrically isolated from the resistive-heating conductors, wherein such other traces/conductors may be used to provide power and/or sensor signals to/from the thermistor(s) 111. For example, the resistive-heating conductors may be designed to follow certain paths/routing that can allow for the routing of conductors to and from the thermistor(s) 111 without shunting/contacting with the resistive-heating conductors. Such routing may or may not be in the same substrate layer as the heating conductors/traces.

The thermistor(s) 111 may be disposed on, or in proximity to, a patient-facing side of the heating device(s) and/or substrate thereof. The thermistor(s) 111 may be used to provide sensor signals indicating a temperature of the heating device(s) and/or proximate area, which may include the skin/tissue of the patient in the area of the popliteal fossa and/or the temperature of the sleeve proximate to the heating device(s). In some embodiments, the thermistor(s) 111 may be centered, or near center, with respect to a center of mass of the heating device(s).

The heating device(s) may include conformal and flexible substrates with, for example, printed traces that when energized create heat. For example, the substrate may comprise a plane or film that is configured to bend in one or more directions, such that the device and/or pad can conform to compound shapes on the human body.

FIG. 1B provides a front view and a side view of the system 100. The system 100 may comprise stretchable fabrics to which the first heating device 108 and/or second heating device 110 may be printed. In some examples, the upper sleeve 112 and/or lower sleeve 114 may comprise a single layer of fabric. However, the upper sleeve 112 and/or lower sleeve 114 may comprise multiple layers of fabric and/or the first heating device 108 and/or second heating device 110 may be disposed between layers of the fabric.

FIG. 1C provides a bottom view of the lower sleeve 114 of the system 100 and/or thermal compression device. The lower sleeve 114 may comprise the second heating device 110, which may be printed and/or otherwise attached to fabric of the lower sleeve 114.

FIG. 1D provides a perspective view of the system 100. In some examples, the compression device 101 and/or upper sleeve 112 may comprise one or more attachment features 115 (e.g., Velcro pads) to facilitate attachment of the system to a patient’s leg.

The one or more attachment features 115 may facilitate the upper sleeve 112 and/or compression device 101 forming an adjustable strap to help to compress the heating element(s) onto the target body part, which can include a knee, foot, arm, shoulder, head, and/or other body part.

FIG. 1E provides front and back views of the system 100. In some examples, the compression device 101 and/or upper sleeve 112 may comprise patient side graphics for correct application to the leg. Additionally, the system 100 may comprise graphics to show where the heaters are applied to the area behind the knee and on the bottom of the foot (e.g., to facilitate printing of the first heating device 108 and/or second heating device 110 to the upper sleeve 112 and/or lower sleeve 114).

The first heating device 108 and/or additional heating elements may include certain control circuitry, which may be associated with any of the illustrated components.

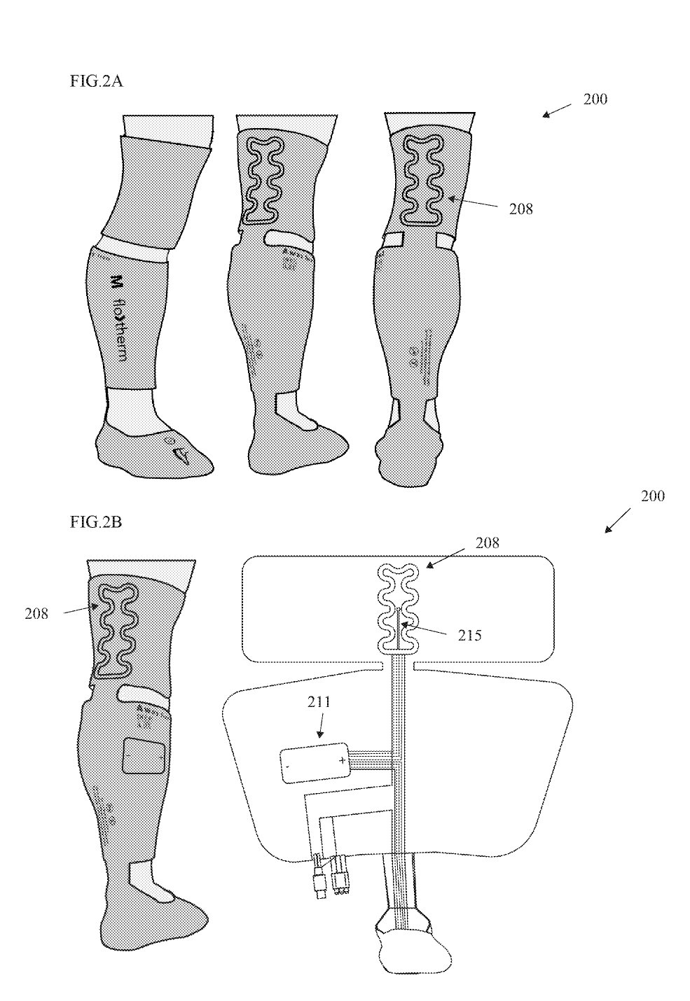

FIGS. 2A and 2B illustrate an example heating and/or compression system 200 disposed on a patient’s leg, in accordance with one or more examples. FIG. 2A provides perspective and back views of the system 200. The system 200 may be configured to conform tightly to the leg to ensure a first heating element 208 and/or additional heating element maintain contact with the patient’s skin. The first heating element 208 and/or additional heating elements may be stretchable and/or may be applied to stretchable surfaces of the system 200 and/or may be positioned for alignment with the patient’s popliteal, foot and/or other areas. In some examples, the system 200 may comprise a thermistor 215 and/or sensor adapted for placement in direct contact with the skin to assure conformity to a maximum of 43-degrees centigrade heating. Information from the thermistor 215 may be monitored every few seconds to allow the controller to maintain correct temperature from a low, medium, and high setting.

The system 200 may comprise a temperature-management sleeve including a plurality of heating pads, including the first heating element 208 situated/disposed on or adjacent to the popliteal fossa region of the patient’s limb, which may generally be on a backside of the limb 10 opposite the knee 8. The sleeve may further include a second heating element (not shown) disposed in a region of the sleeve that is configured to be placed on and/or in proximity to the sole of a foot of the patient. The heating pads may be part of a heater assembly that is attachable and/or configured to be coupled to (e.g., printed to) the sleeve.

The sleeve further includes a calf portion, which may be associated with one or more compression bladders, which may be implemented to provide sequential compression for the promotion of blood flow within the limb and/or prevention/treatment of deep vein thrombosis. In some embodiments, sequential compression may be implemented in the calf portion simultaneously with heating of the sole of the foot and the popliteal fossa using the heating pads. Such simultaneous implementation/execution of the heating and sequential compression as provided by the sleeve system can advantageously provide improved heating and/or temperature maintenance for a patient during a surgical procedure, thereby reducing the risk of hypothermia development as described in detail herein.

In some embodiments, the calf portion of the sleeve is detachable from a foot portion and/or a popliteal fossa portion of the sleeve. For example, the sleeve may include a detachable feature or region configured to allow for detachment of the foot portion from the calf portion. For example, such detachment/attachment means may comprise a Velcro coupling, and/or other type of clip, strap, tie, snap, or other physical attachment means, mechanism or tearaway feature, wherein the structure of the foot portion can be separated from and/or attached to the calf portion. The detachability of the foot portion and/or popliteal fossa portion from the calf portion may allow for the calf portion and associated sequential compression functionality to remain on the limb and/or be implemented even after removal of the foot and/or popliteal fossa portions of the sleeve, which may be desirable for the purpose of an increasing patient comfort and/or allowing for patient mobility in certain situations.

The sleeve includes certain physical connectors/couplings, such as one or more calf portion straps, foot portion straps, and/or popliteal fossa portion straps, which may serve to secure the sleeve to the limb. The sleeve may further include certain flexibility-enhancement features, such as a knee cut-out/opening and/or ankle cut-out/opening. The ankle opening can advantageously allow for rotation of the limb at the ankle with reduced discomfort and/or physical strain on the sleeve. The knee opening may advantageously allow for bending of the limb at the knee with reduced obstruction and/or discomfort to the patient.

The sleeve includes a connector assembly, which may comprise a physical connector for a fluid source, which may provide heated or non-heated fluid for inflation of the compression bladder(s) and/or heel pad, and/or may allow for electrical coupling of the heater assembly associated with the heating pads with an electrical power source, which may be provided from a control unit or the like.

Embodiments of the present disclosure provide flexible resistive heater device/pad designs to provide flexibility to conform to compound convexities and concavities of particular anatomies/areas of the human form, such that the heating pads can be utilized to efficiently transfer thermal energy to venous and/or arterial blood vessels in areas where such vessels are relatively close to the skin.

Generally, the popliteal fossa is a diamond-shaped depression/area located posterior to the knee joint. Various nerves and blood vessels pass from the thigh to the lower leg by traversing through the popliteal fossa. For example, the popliteal artery, the popliteal vein, the superior medial genicular artery, and the small saphenous vein run through the popliteal fossa. The blood vessels of the popliteal fossa lie in relatively close proximity to the surface of the skin in the area between/bounded-by the semimembranosus, biceps femoris, and gastrocnemius muscles.

Due to the exposure of the various blood vessels of the popliteal fossa relatively closely to the skin, placement of a heating pad over a substantial portion of the popliteal fossa can provide for relatively efficient increasing of the patient’s systemic temperature by transferring substantial amounts of heat/thermal energy into the blood flowing through such blood vessels, wherein the patient’s temperature can be increased and/or maintained through circulation of the heated blood throughout the body.

The vertical placement/positioning of the heating pad on the leg can be determined/designed based on the relative position of the exposed blood vessel area to the knee structure. For example, The exposed blood vessel center is generally somewhat higher/above the center of the kneecap.

The heating pad is advantageously designed to allow for contortion thereof to facilitate the resting/placement of the heating pad and/or heating element(s) against the compound surface of the popliteal fossa, which generally presents a depression with nonsymmetrical/nonuniform contours, such contoured surface generally varying from patient to patient.

FIG. 2B provides a perspective view and a transparent front view of the system 200. In some examples, the system 200 may comprise one or more batteries 211 and/or energy sources to providing current and/or heating energy to the first heating element 208 and/or additional heating elements. The one or more batteries 211 may be flexible and/or may be adapted to conform to the patient’s body shape. The one or more batteries 211 may comprise energy storage devices designed to bend, twist, and conform to various shapes while maintaining functionality, making them advantageous for wearable and flexible electronics.

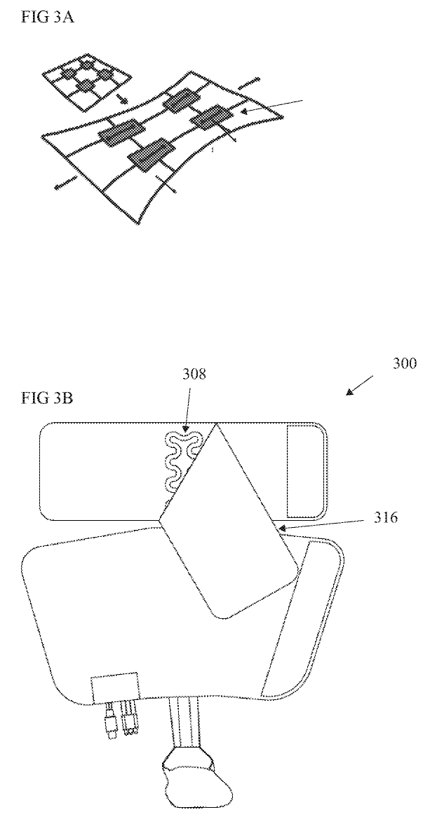

FIGS. 3A and 3B illustrate example heating elements of a system 300 in accordance with one or more examples. FIG. 3A provides perspective views of an example heating element 308 in a relaxed (e.g., compressed) form and in a stretched (e.g., expanded) form. The heating element 308 may comprise electronic leads on plastic designed to integrate stretchable and rigid components, allowing for flexible electronic devices. The heating element 308 may comprise any suitable materials (e.g., Styrene-Ethylene-Butylene-Styrene (SEBS), rubber, metals, etc.) which can achieve over 250% stretchability while maintaining conductivity. This stretchability allows for improved patient comfort during heating and/or compression.

FIG. 3B provides a front view of the system 300. In some examples, the system 300 may comprise multiple layers of fabric. For example, a covering layer 316 may be applied over the heating element 308 to dispose the heating element 308 between multiple layers of material (e.g., fabric) to aid in patient comfort and robustness of the system 300. The covering layer 316 may be stretchable.

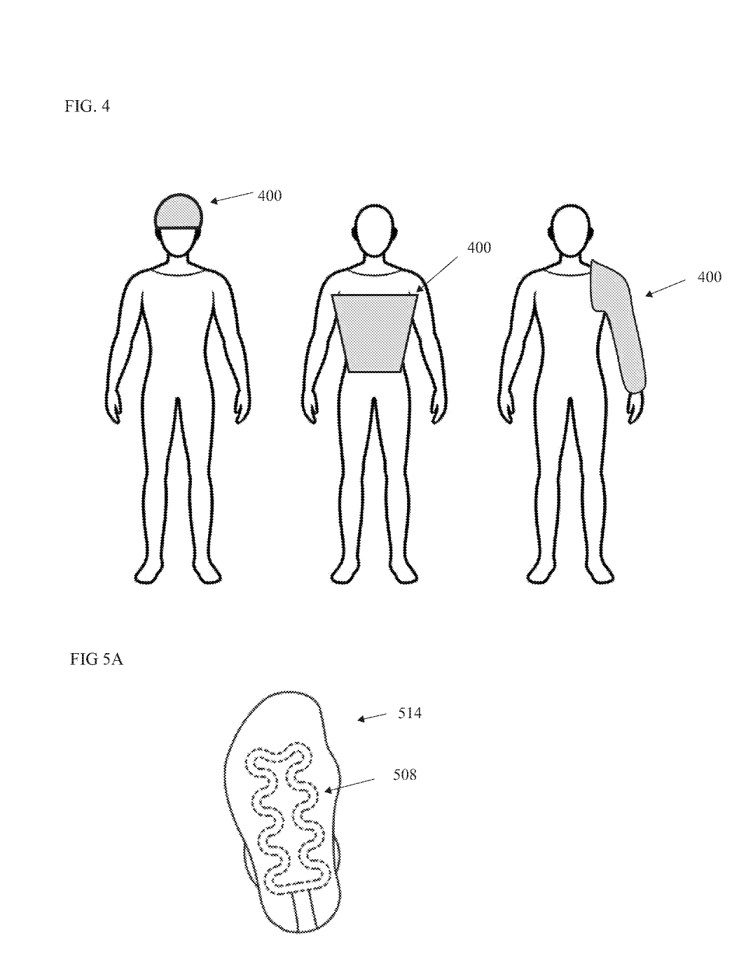

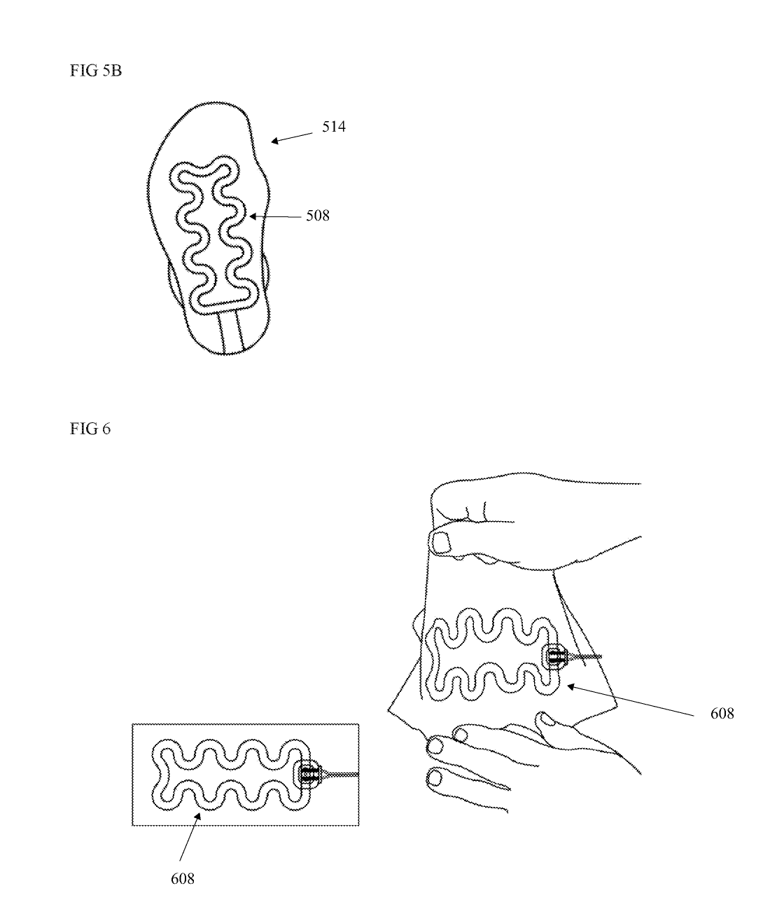

FIG. 4 illustrates example placement of the heating and/or compress systems 400 described herein. While some examples are described with respect to a patient’s leg, this is for exemplary purposes and systems 400 described herein may be adapted for placement on various parts of a patient’s body. For example, system 400 may be applied to a patient’s shoulder, arms, thoracic area, and/or head.

FIGS. 5A and 5B illustrate an example lower sleeve 514 in accordance with one or more examples. FIG. 5A illustrates the lower sleeve 514 in section line denoting it is touching skin of a patient. FIG. 5B illustrates the lower sleeve 514 in solid lines denoting it is disposed on fabric and/or away from skin. The lower sleeve 514 may be adapted for application to a patient’s foot and/or may comprise a heating element 508 adapted for positioning along a bottom of the patient’s foot.

FIG. 6 illustrates two states of an example heating element 608 in accordance with one or more examples. The heating element 608 is shown in a relaxed and in a stretched form. In some examples, the heating element 608 (e.g., a printed and/or applied flexible conductive heater) can be stretched at least 25% to conform to any compound body part.

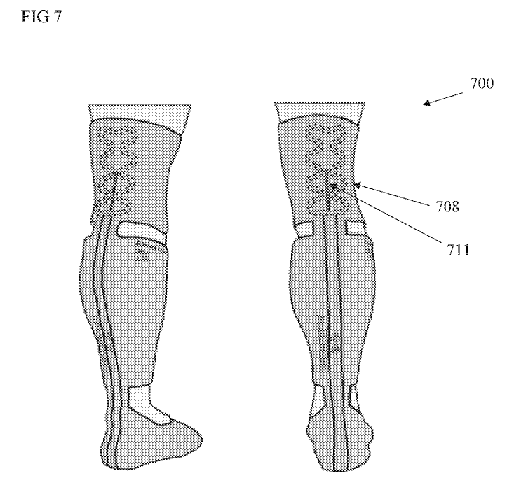

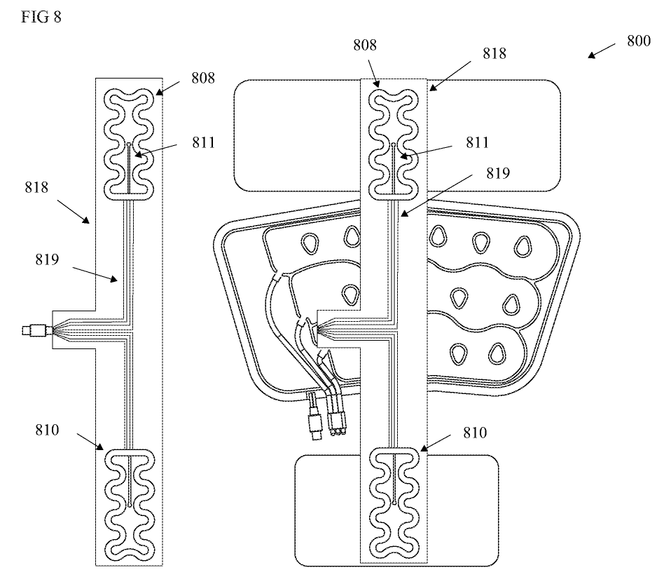

FIG. 7 back and perspective views of an example heating and/or compression system 700 in accordance with one or more examples. The system 700 may comprise stretchable fabric along a length of the system 700 and/or may comprise one or more applied conductive heaters 708, a thermistor 711, and/or flexible electronic traces (e.g., conductive lines) inside and/or along the stretchable fabric.

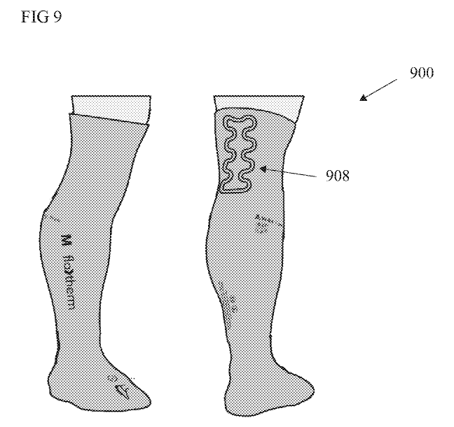

FIG. 8 illustrates heating elements of a system 800 in accordance with one or more examples. The system 800 can include a first heating element 808 and/or a second heating element 810 which may be disposed along a substrate 818 (e.g., sheet of plastic and/or other material) and/or may be interconnected by a network of wires 819 to provide electrical energy to the first heating element 808 and/or the second heating element 810. The first heating element 808, second heating element 810, substrate 818, and/or wires 819 may be flexible. The substrate 818 may comprise a flexible thin plastic sheet that may be reusable and/or can be cleaned with typical hospital cleansers. The substrate 818 may be placed into one or more sleeves and/or compression devices as described herein. The system 800 may be reusable. In some examples, the first heating element 808 and/or second heating element 810 may be electronically coupled to an electronic microchip adapted to count the number of uses and/or can deactivate heating after a given number of uses and/or at a defined time.

The system 800 may comprise one or more thermistors 811 that may be associated with each of the first heating element 808 and/or second heating element 810. For example, each of the first heating element 808 and/or second heating element 810 may be disposed adjacent to and/or enclosing a thermistor disposed at center portions of the first heating element 808 and/or second heating element 810. The thermistor (s) 811 may be electrically coupled to one or more traces of the first heating element 808 and/or second heating element 810.

In some embodiments, the system 800 includes certain control circuitry (e.g., wires 819), which may be implemented on one or more circuit boards or other electrical modules/devices electrically coupled to the wiring in some manner. For example, in some embodiments, the control circuitry may be implemented at least in part in one or more boards and/or chips disposed adjacent to and/or on one or more of the heating pads. For example, the heating pads may comprise substrates on/in which resistive heating conductors are disposed, wherein the control circuitry is implemented in/on an area of the substrate that is not covered by the resistive heating conductors. The term “control circuitry” is used herein according to its broad and ordinary meaning, and may refer to any collection of processors, processing circuitry, processing modules/units, chips, dies (e.g., semiconductor dies including come or more active and/or passive devices and/or connectivity circuitry), microprocessors, micro-controllers, digital signal processors, microcomputers, central processing units, field programmable gate arrays, programmable logic devices, state machines (e.g., hardware state machines), logic circuitry, analog circuitry, digital circuitry, and/or any device that manipulates signals (analog and/or digital) based on hard coding of the circuitry and/or operational instructions. Control circuitry referenced herein may further comprise one or more, storage devices, which may be embodied in a single memory device, a plurality of memory devices, and/or embedded circuitry of a device. Such data storage may comprise read-only memory, random access memory, volatile memory, non-volatile memory, static memory, dynamic memory, flash memory, cache memory, data storage registers, and/or any device that stores digital information. It should be noted that in embodiments in which control circuitry comprises a hardware and/or software state machine, analog circuitry, digital circuitry, and/or logic circuitry, data storage device(s)/register(s) storing any associated operational instructions may be embedded within, or external to, the circuitry comprising the state machine, analog circuitry, digital circuitry, and/or logic circuitry.

FIG. 9 provides side and perspective views of an example system 900 for providing compression and/or heating to a patient in accordance with one or more examples. The system 900 may have a form of a sock and/or stocking and/or may be stretchable to conform to a user’s leg and/or other body part. In some examples, the system 900 may comprise a sequential bladder that is stretchable and is adhered to the stretchable stocking fabric along with a heating element 908.

The various heating elements, thermistors (e.g., temperature monitors), and/or flexible wire traces described herein may be printed and/or applied to a flexible substrate and/or sheet of plastic and/or other material. The substrate and attached components may be movable and/or may be reused numerous times and be sterilized by cleaning solutions. This reusable heater system may then be placed and/or adhered into a disposable fabric and sequential compression system for use in heating the patient.

### Additional Embodiments

Depending on the embodiment, certain acts, events, or functions of any of the processes or algorithms described herein can be performed in a different sequence, may be added, merged, or left out altogether. Thus, in certain embodiments, not all described acts or events are necessary for the practice of the processes.

Conditional language used herein, such as, among others, “can,” “could,” “might,” “may,” “e.g.,” and the like, unless specifically stated otherwise, or otherwise understood within the context as used, is intended in its ordinary sense and is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous, are used in their ordinary sense, and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y and Z,” unless specifically stated otherwise, is understood with the context as used in general to convey that an item, term, element, etc. may be either X, Y or Z. Thus, such conjunctive language is not generally intended to imply that certain embodiments require at least one of X, at least one of Y and at least one of Z to each be present.

It should be appreciated that in the above description of embodiments, various features are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Moreover, any components, features, or steps illustrated and/or described in a particular embodiment herein can be applied to or used with any other embodiment(s). Further, no component, feature, step, or group of components, features, or steps are necessary or indispensable for each embodiment. Thus, it is intended that the scope of the inventions herein disclosed and claimed below should not be limited by the particular embodiments described above, but should be determined only by a fair reading of the claims that follow.

It should be understood that certain ordinal terms (e.g., “first” or “second”) may be provided for ease of reference and do not necessarily imply physical characteristics or ordering. Therefore, as used herein, an ordinal term (e.g., “first,” “second,” “third,” etc.) used to modify an element, such as a structure, a component, an operation, etc., does not necessarily indicate priority or order of the element with respect to any other element, but rather may generally distinguish the element from another element having a similar or identical name (but for use of the ordinal term). In addition, as used herein, indefinite articles (“a” and “an”) may indicate “one or more” rather than “one.” Further, an operation performed “based on” a condition or event may also be performed based on one or more other conditions or events not explicitly recited.

Unless otherwise defined, all terms (including technical and scientific terms) used herein have the same meaning as commonly understood by one of ordinary skill in the art to which example embodiments belong. It be further understood that terms, such as those defined in commonly used dictionaries, should be interpreted as having a meaning that is consistent with their meaning in the context of the relevant art and not be interpreted in an idealized or overly formal sense unless expressly so defined herein.

The spatially relative terms “outer,” “inner,” “upper,” “lower,” “below,” “above,” “vertical,” “horizontal,” and similar terms, may be used herein for ease of description to describe the relations between one element or component and another element or component as illustrated in the drawings. It be understood that the spatially relative terms are intended to encompass different orientations of the device in use or operation, in addition to the orientation depicted in the drawings. For example, in the case where a device shown in the drawing is turned over, the device positioned “below” or “beneath” another device may be placed “above” another device. Accordingly, the illustrative term “below” may include both the lower and upper positions. The device may also be oriented in the other direction, and thus the spatially relative terms may be interpreted differently depending on the orientations.

Unless otherwise expressly stated, comparative and/or quantitative terms, such as “less,” “more,” “greater,” and the like, are intended to encompass the concepts of equality. For example, “less” can mean not only “less” in the strictest mathematical sense, but also, “less than or equal to.”

What is claimed is:

1. A heating assembly comprising:
a flexible sleeve adapted to fit over a portion of a patient’s body, wherein the flexible sleeve is stretchable to conform to the patient’s body; and
a first flexible heating element adhered to the flexible sleeve, wherein the first flexible heating element is stretchable to bend and stretch with the flexible sleeve.

2. The heating assembly of claim 1, further comprising a flexible substrate disposed between the flexible sleeve and the first flexible heating element.

3. The heating assembly of claim 1, wherein the first flexible heating element comprises one or more electrically conductive heating traces configured to radiate heat therefrom in response to electrical current flowing through the one or more electrically conductive heating traces.

4. The heating assembly of claim 1, wherein the first flexible heating element is adhered to an upper portion of the flexible sleeve to position the first flexible heating element adjacent to the patient’s knee.

5. The heating assembly of claim 1, further comprising a second heating element adhered to the flexible sleeve, wherein the second heating element is stretchable to bend and stretch with the flexible sleeve.

6. The heating assembly of claim 5, wherein the second heating element is adhered to a lower portion of the flexible sleeve to position the second heating element adjacent to the patient’s foot.

7. The heating assembly of claim 6, further comprising a compression bladder attached to the flexible sleeve between the first heating element and the second heating element.

8. The heating assembly of claim 1, further comprising a thermistor disposed adjacent to the first heating element to sense skin temperature.

9. The heating assembly of claim 8, further comprising a controller electrically coupled to the thermistor to communicate with the thermistor and adjust heating temperature at the first heating element in response to the sensed skin temperature.

10. The heating assembly of claim 9, further comprising a compression bladder attached to the flexible sleeve, wherein the controller is electrically coupled to the compression bladder to control compression of the compression bladder in response to the sensed skin temperature.

11. The heating assembly of claim 1, wherein the flexible sleeve is adapted for placement on a patient’s arm, shoulder, thoracic area, or head.

12. The heating assembly of claim 1, wherein the first heating element is printed to the flexible sleeve.

13. The heating assembly of claim 1, further comprising one or more electrical leads coupled to the first heating element, wherein the one or more electrical leads are flexible to conform to bend and stretch with the flexible sleeve.

14. The heating assembly of claim 13, wherein the one or more electrical leads are printed to the flexible sleeve.

15. The heating assembly of claim 13, further comprising a flexible substrate coupled to the flexible sleeve and adapted to stretch and bend with the flexible sleeve, wherein the one or more electrical leads are coupled to the flexible substrate.

16. A heating assembly comprising:
a flexible sleeve adapted to fit over a portion of a patient’s body, wherein the flexible sleeve is stretchable to conform to the patient’s body;
a first flexible heating element adhered to the flexible sleeve, wherein the first flexible heating element is stretchable to bend and stretch with the flexible sleeve;
a second flexible heating element adhered to the flexible sleeve, wherein the second flexible heating element is stretchable to bend and stretch with the flexible sleeve; and
a compression bladder attached to the flexible sleeve between the first flexible heating element and the second flexible heating element.

17. The heating assembly of claim 16, further comprising a flexible substrate disposed between the flexible sleeve and the first flexible heating element.

18. The heating assembly of claim 16, wherein the first flexible heating element comprises one or more electrically conductive heating traces configured to radiate heat therefrom in response to electrical current flowing through the one or more electrically conductive heating traces.

19. A heating assembly comprising:
a flexible sleeve adapted to fit over a portion of a patient’s body, wherein the flexible sleeve is stretchable to conform to the patient’s body;
a flexible substrate adhered to the flexible sleeve;
a first flexible heating element adhered to the flexible substrate, wherein the first flexible heating element is stretchable to bend and stretch with the flexible sleeve; and
a second flexible heating element adhered to the flexible substrate.

20. The heating assembly of claim 19, further comprising a compression bladder attached to the flexible sleeve between the first flexible heating element and the second flexible heating element.
